(19) United States
(12) Patent Application Publication
(10) Pub. No.: US 2026/0359753 A1
(43) Pub. Date: Nov. 12, 2026

(54) AGENT MANAGEMENT FOR WORKFLOW PROCESSES

(71) Applicant: SAP SE, Walldorf (DE)

(72) Inventors: Riswan LATHIF, Munich (DE); Matthias SCHNEIDER, Munich (DE)

(21) Appl. No.: 19/203,695

(22) Filed: May 9, 2025

(51) Int. Cl. G06Q 10/0631

(52) U.S. Cl. CPC G06Q 10/06316

(57) ABSTRACT

Disclosed herein are a system, method, and computer program product embodiments for an agent management system for managing agents utilized to perform operations of a workflow. An embodiment operates by receiving a request to initiate a workflow process. The embodiment may determine one or more agents for implementing the workflow process based on a manifest that describes the functionality of the workflow process. The embodiment may determine whether any of the determined agent(s) are already initiated. For the agent(s) that are uninitiated, the embodiment may generate code that performs portions of the functionality corresponding to such agent(s). The embodiment may then execute the workflow process based on the code generated for such agent(s).

### BACKGROUND

Business applications are often complex applications that run with various interdependencies, for example, between business objects, data, and user interaction. Business applications may leverage workflows to automate and streamline certain processes, improve efficiency, organize tasks, and manage data flow. Certain processes may be automated utilizing agents, where each agent is configured to perform a set of tasks specific to the agent. Given the complexity of business applications, hundreds of agents may be utilized to execute a given workflow. As the number of agents increase, so does the amount of compute resources required to manage and execute such agents.

### BRIEF DESCRIPTION OF THE DRAWINGS

The accompanying drawings are incorporated herein and form a part of the specification.

FIG. 1 shows a block diagram of a system configured to manage agents of a workflow process, according to some embodiments.

FIG. 2 is a block diagram of a workflow agent management system, according to some embodiments.

FIG. 3 is a flowchart for a method for managing agents of a workflow process, according to some embodiments.

FIG. 4 is a flowchart for a method for transitioning an agent to an idle state, according to some embodiments.

FIG. 5 is a flowchart for a method for determining agents based on a manifest, according to some embodiments.

FIG. 6 is a flowchart for a method for terminating an agent, according to some embodiments.

FIG. 7 is a flowchart for a method for terminating execution of an agent, according to some embodiments.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

As discussed in the Background Section above, agent-based workflow processes require an extensive amount of compute resources. This challenge necessitates the development of a robust and intelligent workflow management system that is configured to launch and terminate agents specific to a workflow on demand.

Provided herein are a system, apparatus, device, method and/or computer program product embodiments, and/or combinations and sub-combinations thereof, for an agent management system for managing agents utilized to perform operations of a workflow. For example, a request to initiate a workflow process may be received. One or more agents for implementing the workflow process may be determined based on a manifest that describes the functionality of the workflow process. A determination is made as to whether any of the determined agent(s) are already initiated. For the agent(s) that are uninitiated, code that performs portions of the functionality corresponding to such agent(s) is generated. The workflow process is executed based on the code generated for such agent(s).

The agent management system may initiate agents during runtime of workflow process as they are needed rather than compiling all the agents required for a workflow process before execution of the workflow process. In addition, the agent management system may monitor which agents are actively used and place agents that are not being actively used in an idle state. Moreover, the agent management system may determine which agents have been sitting idle for a particular time period and terminate execution of such agents.

Accordingly, the techniques described herein improve the functioning of a computing system. For example, by monitoring the state of agents and placing agents in an idle state or terminating inactive agents when they are not being utilized, various compute resources (e.g., processor cycles, memory, storage, power etc.) that are normally consumed from executing such agents are conserved.

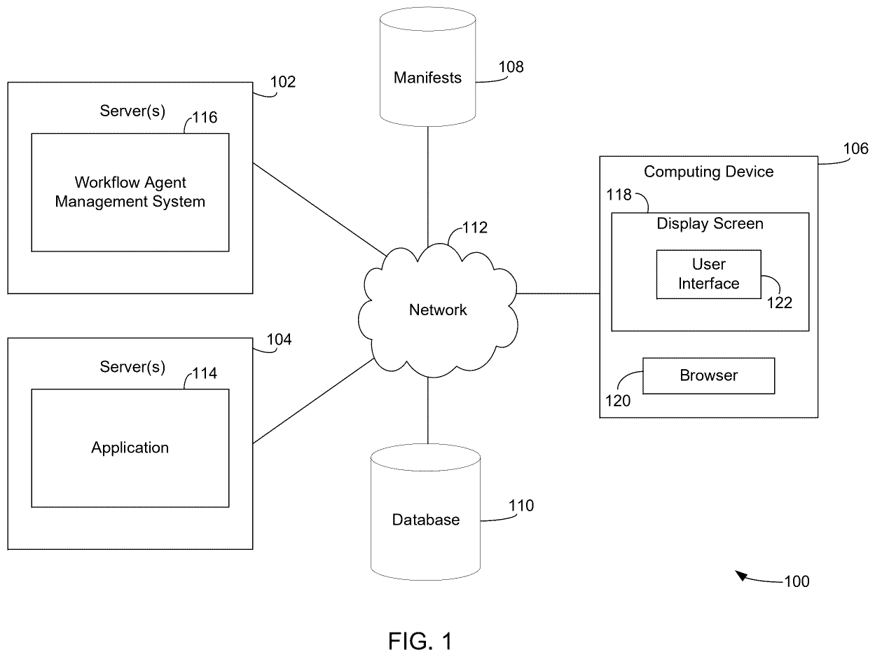

FIG. 1 shows a block diagram of a system 100 configured to manage agents of a workflow process, according to some embodiments. As shown in FIG. 1, system 100 includes one or more servers 102, server(s) 104, a computing device 106, a first database 108 and a second database 110. Server(s) 102, server(s) 104, computing device 106, first database 108, and second database 110 may be communicatively coupled to each other via a network 112. Network 112 may comprise one or more networks such as local area networks (LANs), wide area networks (WANs), enterprise networks, the Internet, etc., and may include one or more of wired and/or wireless portions.

In an embodiment, server(s) 102 and/or 104 may form a network-accessible server set (e.g., a cloud-based environment or platform). Server(s) 102 and/or 104 may be accessible via network 112 (e.g., in a “cloud-based” embodiment) to build, deploy, and manage applications and services. Server(s) 102 and/or 104 may be co-located (e.g., housed in one or more nearby buildings with associated components such as backup power supplies, redundant data communications, environmental controls, etc.) to form a datacenter, or may be arranged in other manners. Accordingly, in an embodiment, server(s) 102 and/or 104 may be a datacenter in a distributed collection of datacenters.

Server(s) 104 may be configured to execute one or more software applications (or “applications”) and/or services. Server(s) 104 may also be configured for specific uses. For example, as shown in FIG. 1, server(s) 104 may be configured to execute an application 114. An example of application 114 includes, but is not limited to, an enterprise resource planning software application that incorporates various business processes. Such business processes include, but are not limited to, operations (e.g., sales and distribution, materials management, production planning, logistics execution, and quality management), financials (e.g., financial accounting, management accounting, financial supply chain management, etc.), human capital management (e.g., training, payroll, recruiting, etc.), and corporate services (e.g., travel management, environment, health and safety, and real estate management).

A user may access and/or utilize application 114 via computing device 106. As shown in FIG. 1, computing device 106 includes a display screen 118 and a browser 120. A user may access and/or utilize application 114 by interacting with an application at computing device 106 capable of accessing application 114. For example, the user may use browser 120 to traverse a network address (e.g., a uniform resource locator) to application 114 or a website that is communicatively coupled to application 114, which invokes a user interface 122 (e.g., a web page) in a browser window rendered on computing device 106. By interacting with user interface 122, the user may access and/or invoke application 114. For example, the website may be a retail website via which a user may purchase an item. Application 114 may be invoked responsive to the user purchasing the item. Computing device 106 may be any type of stationary device, such as a desktop computer or PC (personal computer), or mobile computing device (such as a laptop computer, a notebook computer, a tablet computer, etc.).

Server(s) 102 may be configured to execute one or more software applications (or “applications”) and/or services. Server(s) 102 may also be configured for specific uses. For example, as shown in FIG. 1, server(s) 102 be configured to execute a workflow agent management system 116. Workflow agent management system 116 may be configured to initiate one or more agents each configured to execute a portion of a workflow process. In some embodiments, the workflow process is configured to perform any of the business processes described above. To determine which agent(s) to initiate, workflow agent management system 116 may analyze a manifest associated with the workflow process. The manifest may provide a definition and/or description of the workflow. In some embodiments, the definition and/or description is a natural language-based description that describes the functionality of the workflow process and at least one of access privileges or access restrictions of the workflow process (e.g., uniform resource identifiers of computing devices and/or websites that the workflow process is allowed to or not allowed to access). In accordance with such embodiments, workflow agent management system 116 analyzes the natural language-based description utilizing natural language processing (NLP) techniques, determines the agent(s) to be utilized for executing the workflow process, and initiates such agent(s). Such NLP techniques will be known to persons skilled in the relevant art(s).

In some embodiments, workflow agent management system 116 utilizes generative artificial intelligence (AI) (e.g., a large language model (LLM)) that automatically generates executable code corresponding to each the determined agent(s). For example, the LLM may parse the manifest and automatically generate executable code configured to perform the functionality described by the description included in the manifest. The LLM may be trained on natural language text and a plurality of different source code examples. Workflows executed based on such LLM-based agents may be referred to as agentic workflows. Agentic workflows may be artificial intelligence (AI)-driven processes where autonomous AI agents make decisions, take actions, and coordinate tasks with minimal human intervention. Such workflows leverage core components of intelligent agents, such as resonating, planning and tool use to execute complex tasks efficiently.

First database 108 may store a plurality of manifests, where each manifest corresponds to a particular workflow process. First database 108 may be configured to determine a manifest from the plurality of manifests based on a request that initiates a particular workflow process. For instance, application 114 may receive a request to initiate a workflow process (e.g., via computing device 106). The request (or an indication thereof) may be provided to workflow agent management system 116. Workflow agent management system 116 may analyze the request (or indication thereof) to determine the type of workflow that is to be initiated. Upon determining the type of workflow, workflow agent management system 116 may provide a query to first database 108 that specifies the type of workflow. First database 108 may return the manifest corresponding to the type of workflow.

Examples of requests include, but are not limited to, finance and accounting-based requests for capturing customer transactions and managing customer accounts (e.g., accounts receivable-related and accounts payable-related transactions (e.g., invoice posting, credit memo posting, down payments, invoice payments, etc.), closing an entity's books, generating financial reports, etc.). The requests may also be related to human resource management processes for generating attendance and payroll records. The requests may further be related to sourcing and procurement processes (e.g., requests for quotes, generates contracts, etc.). The requests may also be related to sales processes (e.g., for generating records pertaining to communications between the entity and customers (or potential customers), requests order management records, etc.). The requests may further be related to manufacturing processes (e.g., requests for generating production scheduling records, quality management records, etc.). It is noted that that the requests described above are exemplary and the requests may be related to other business-related processes and/or may comprise a combination of the processes described above.

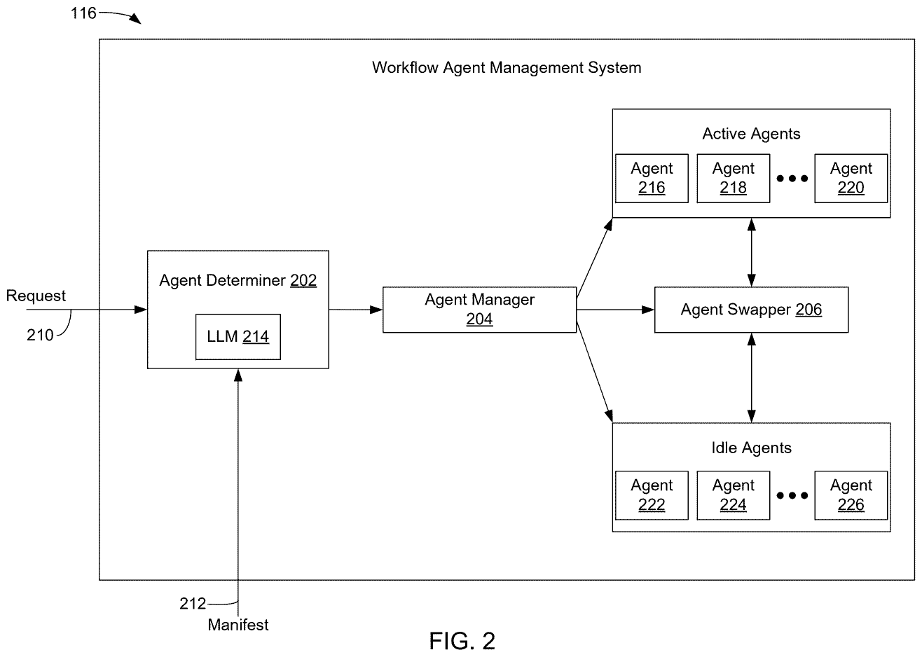

Workflow agent management system 116 may further be configured to dynamically allocate system resources for initiating and executing agent(s). For example, workflow agent management system 116 may determine whether an agent has been unused for a particular period of time and transition the agent to an idle state. Workflow agent management system 116 may further cause an agent to transition from an idle state to an active state based on a determination that the agent is to be utilized to perform a portion of a workflow process. Workflow agent management system 116 may terminate an agent that has been in an idle state for a particular period of time. Additional details regarding workflow agent management system 116 are provided below with reference to FIG. 2.

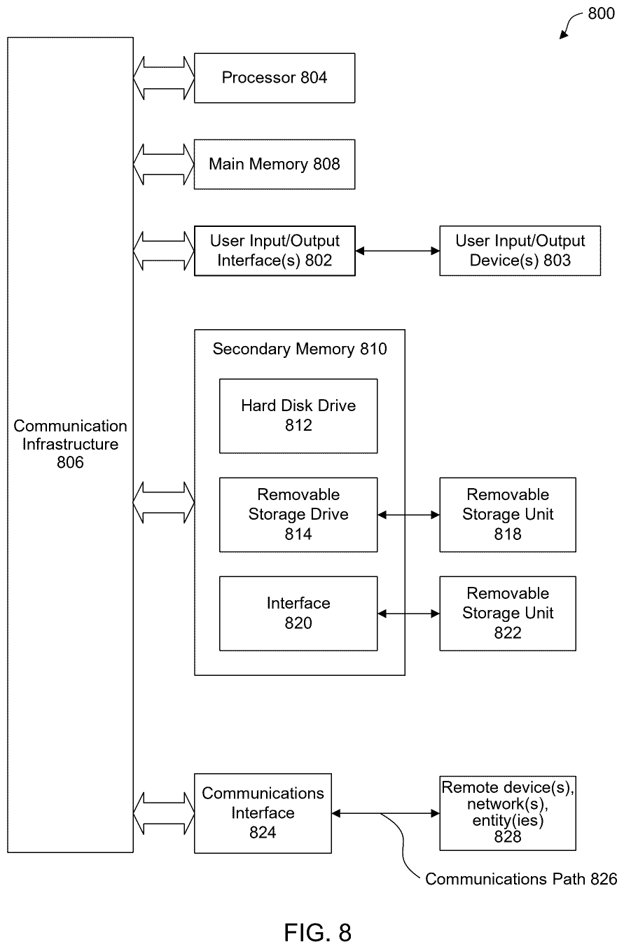

The resources operated on by a workflow process (e.g., records, contracts, etc.) may be stored in second database 110. In an embodiment, databases 108 and 110 are managed by and accessed via a corresponding database management system (DBMS), which is not shown in FIG. 1 for the sake of simplicity. Databases 108 and 110 and the corresponding DBMSs may be implemented on one or more computer systems, such as computer system 800 as described below in reference to FIG. 8. Databases 108 and 110 and the corresponding DBMSs may also be implemented on one or more servers of an enterprise network and/or a cloud computing network and accessed via a client computer system that is connected thereto, although these examples are not intended to be limiting.

FIG. 2 is a block diagram of workflow agent management system 116, according to some embodiments. As shown in FIG. 2, workflow agent management system 116 comprises an agent determiner 202, an agent manager 204, and an agent swapper 206. Each of agent determiner 202, agent manager 204, and agent swapper 206 may be implemented by processing logic that can include hardware (e.g., circuitry, dedicated logic, programmable logic, and/or microcode), software (e.g., instructions executing on a processing device), or a combination thereof. In some embodiments, each of agent determiner 202, agent manager 204, and agent swapper 206 is implemented in one or more software processes executing on one or more processor-based computer systems, such as computer system 800 as described below in reference to FIG. 8.

Agent determiner 202 may be configured to receive a request 210 that initiates a workflow process and determine the type of workflow process that is to be initiated based on request 210. Based on the type of workflow process, agent determiner 202 may obtain a manifest 212 associated with the type of workflow process, for example, from first database 108. Agent determiner 202 may comprise an LLM 214. LLM 214 may be implemented by processing logic that can include hardware (e.g., circuitry, dedicated logic, programmable logic, and/or microcode), software (e.g., instructions executing on a processing device), or a combination thereof. In some embodiments, LLM 214 is implemented in one or more software processes executing on one or more processor-based computer systems, such as computer system 800 as described below in reference to FIG. 8.

LLM 214 may be configured parse manifest 212 and determine agent(s) for performing the workflow process described by manifest 212. LLM 214 may automatically generate executable code for each of the determined agent(s) that is configured to perform the functionality described by the description included in manifest 212. For example, suppose manifest 212 describes a workflow for executing the confirmation of a production order where the market prices of a certain material is 10% below the quoted value in the production order. Based on the description, LLM 214 may determine that at least a database agent is needed for issuing application programming interface (API) calls to a database (e.g., second database 110), a web agent is needed for retrieving the price of the material from the Internet, and a calculator agent is needed for calculating percentages. Responsive to determining that such agents are to be initiated, LLM 214 may automatically generate executable code for each of such agents. The code generated for a particular agent is configured to perform the functionality described in manifest 212 for that agent.

In some instances, an agent required for a particular workflow process may already be initiated and executed. For example, such an agent may also be utilized by a previous instance of the workflow process or another workflow process. As such, the code for the agent was previously generated by LLM 214. In such instances, LLM 214 does not re-generate the code.

Agent manager 204 may be configured to initiate and execute agent(s) generated by agent determiner 202. For example, agent determiner 202 may provide an indication to agent manager 204 indicating which agent(s) are to be executed for a given workflow process. Agent manager 204 may determine whether such agent(s) are already loaded into memory (e.g., memory 808, as shown in FIG. 8) and in an active state or whether such agent(s) are in an idle state. If such agent(s) are not loaded into memory, not in an active state, or not in an idle state, agent manager 208 may send an indication to LLM 214 indicating that such agent(s) have not been initiated. In response, LLM 214 may automatically generate the executable code for the agent and provides the code to agent manager 204. If such agent(s) are in either active state or the idle state, agent manager 208 may send an indication LLM 214 indicating that the agent(s) have already been initiated. In response, LLM 224 may not generate the executable code for the agent because it was previously generated.

Agent manager 204 may initiate an agent by creating a corresponding process in memory. The process corresponds to an instance of a particular agent and may comprise the executable code (or an image thereof). In some embodiments, the process is a daemon process that executes as a background process that can transition between idle and active states. Once the process is loaded into memory, the corresponding agent may be executed by agent manager 204. If an agent has already been initiated and loaded into memory, but is in an idle state, agent manager 204 may cause the agent to transition to an active state based on a determination that the agent is needed to perform an operation. For example, agent manager 204 may provide a command to agent swapper 206, which transitions the agent from an idle state to an active state.

In an example, suppose agent manager 204 initiates a web agent for accessing the market pricing for a certain material via the Internet, an API agent to perform a call to a production order API to obtain the production order price of the material, and a calculator agent to calculate whether the market price is less than the production order price. If the market price is less than the production order price, the calculator agent may send a request to the API agent to call the production order API to confirm the order. However, if the market price is greater than the production order price, agent manager 204 may provide a command to agent swapper 206 that causes the API agent to transition to an idle state. Agent manager 204 may cause the API agent to transition to the active state once the calculator agent determines that the market price is less than the production order price.

Accordingly, agent manager 204 may cause an agent to transition from the active state to an idle state based on a particular event (e.g., based on whether another agent has the requisite information for the workflow to continue to the next step). Agent manager 204 may also cause an agent to transition from the active state to the idle state based on determination that an agent has not been utilized for a predetermined time period. To transition an agent to the idle state, agent manager 204 may provide a command to agent swapper 206 to transition an active agent to an idle state. In some embodiments, when placed in the idle state, the idle agent remains in memory, but does not actively utilize central processing unit (CPU) resources and remains idle until it receives a particular instruction or detects a particular event. When an agent is transitioned to the active state in accordance with such embodiments, the agent resumes consuming CPU resources. In other embodiments, when placed in the idle state, state information of the agent may be save and stored (e.g., by agent swapper 206), but the process corresponding to the agent may be removed from memory. When an agent is transitioned to the active state in accordance with such embodiments, the agent is loaded into memory by agent manager 204, agent swapper 206 utilizes the state information for the agent to configure the agent such that it is able to resume operations from where it left off before being transitioned to the idle state. In either embodiments, compute resources (e.g., processing cycle, memory, I/O, power, etc.) are conserved when an agent is placed in an idle state. In the example shown in FIG. 2, agents 216, 218, and 220 are in an active state, and agents 222, 224, and 226 are in an idle state.

In some embodiments, agent manager 204 is configured to terminate agents that have been in an idle state for a predetermined time period. For example, in response to determining that an agent has been in an idle state for a predetermined time period, agent manager 204 may terminate the process corresponding to the agent and/or delete the state information maintained for the process. By doing so, compute resources (e.g., processing cycle, memory, I/O, power, etc.) are conserved.

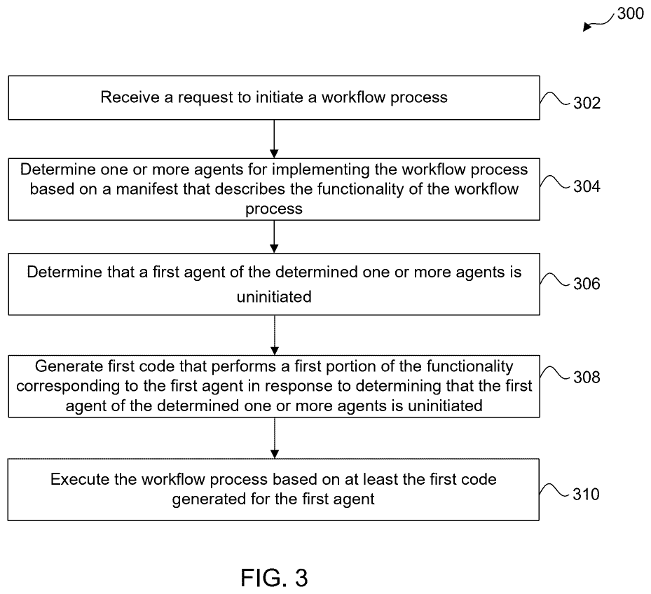

FIG. 3 is a flowchart for a method 300 for managing agents of a workflow process, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1 and 2. However, method 300 is not limited to that example embodiment.

In 302, agent determiner 202 may receive request 210 to initiate a workflow process. For example, the request may be initiated at computing device 106, and the workflow process may be for an application, such as application 114.

In 304, agent determiner 202 may determine one or more agents for implementing the workflow process based on manifest 212 that describes the functionality of the workflow process. Manifest 212 may be obtained from first database 108. In some embodiments, manifest 212 comprises a natural language-based description that describes the functionality of the workflow process and at least one of access privileges or access restrictions of the workflow process. Additional details regarding determining agent(s) for implementing the workflow process are provided below with reference to FIG. 5.

In 306, agent determiner 202 may determine that a first agent of the determined one or more agents is uninitiated. For example, agent determiner 202 may query agent manager 204 to determine whether the determined one or more agents are uninitiated (e.g., not in an active state or an idle state).

In 308, agent determiner 202 may generate first code that performs a first portion of the functionality corresponding to the first agent in response to determining that the first agent of the determined one or more agents is uninitiated. For example, agent manager 204 may provide an indication to agent determiner 202 that the first agent has not yet been initiated, and in response, agent determiner 202 may generate the first code. In some embodiments, agent determiner 202 may generate the first code by generating the first code based on LLM 214 that analyzes the natural language-based description of the manifest.

In 310, agent manager 204 may execute the workflow process based on at least the first code generated for the first agent.

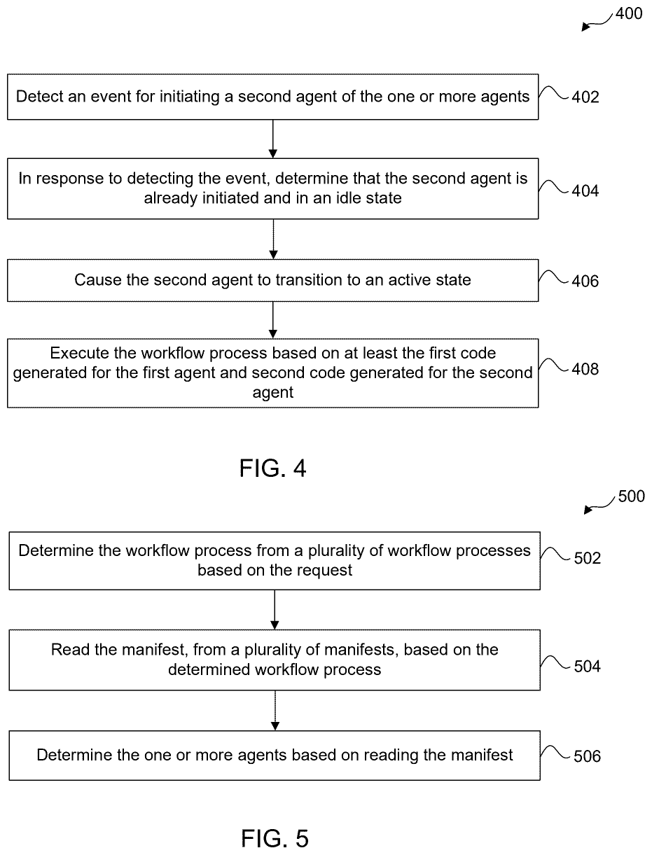

FIG. 4 is a flowchart for a method 400 for transitioning an agent to an idle state, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1 and 2. However, method 400 is not limited to that example embodiment.

In 402, agent manager 204 may detect an event for initiating a second agent of the one or more agents. For example, agent manager 204 may determine that the first agent provided a request to the second agent to perform a particular operation.

In 404, agent manager 204 may, in response to detecting the event, determine that the second agent is already initiated and in an idle state.

In 406, agent manager 204 may cause the second agent to transition to an active state. For example, agent manager 204 may load the second agent into memory and provide a command to agent swapper 206. Based on the command, agent swapper 206 may transition the second agent to an active state and/or utilize the state information for the second agent to configure the second agent such that it is able to resume operations from where it left off before being transitioned to the idle state.

In 408, agent manager 204 may execute the workflow process based on at least the first code generated for the first agent and second code generated for the second agent

FIG. 5 is a flowchart for a method 500 for determining agents based on a manifest, according to some embodiments. Method 1000 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art.

Method 500 shall be described with reference to FIGS. 1 and 2. However, method 500 is not limited to that example embodiment.

In 502, agent determiner 202 may determine the workflow process from a plurality of workflow processes based on request 210.

In 504, agent determiner 202 may read manifest 212, from a plurality of manifests (e.g., stored in first database 108), based on the determined workflow process. For example, the request may indicate the type of workflow process, and agent determiner 202 may query first database 108 for the manifest based on the type of workflow process.

In 506, agent determiner 202 may determine the one or more agents based on reading the manifest.

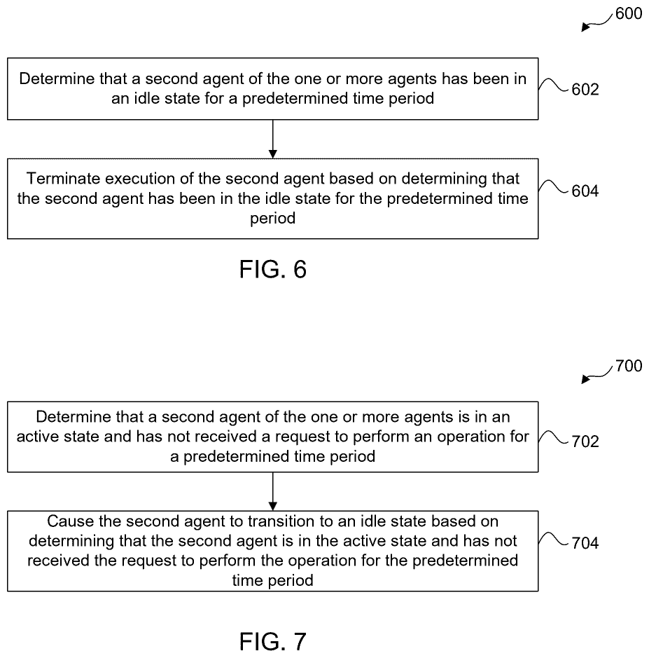

FIG. 6 is a flowchart for a method 600 for terminating an agent, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIGS. 1 and 2. However, method 600 is not limited to that example embodiment.

In 602, agent manager 204 may determine that a second agent of the one or more agents has been in an idle state for a predetermined time period. For example, agent manager 204 may maintain a timer that keeps track of how long the second agent has been in the idle state.

In 602, agent manager 204 may terminate execution of the second agent based on determining that the second agent has been in the idle state for the predetermined time period.

FIG. 7 is a flowchart for a method 700 for terminating execution of an agent, according to some embodiments. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIGS. 1 and 2. However, method 700 is not limited to that example embodiment.

In 702, agent manager 204 may determine that a second agent of the one or more agents is in an active state and has not received a request (e.g., from the first agent) to perform an operation for a predetermined time period.

In 704, agent manager 204 may cause the second agent to transition to an idle state based on determining that the second agent is in the active state and has not received the request to perform the operation for the predetermined time period. For example, agent manager 204 may provide a command to agent swapper 206 to transition the second agent to the idle state. In another example, agent swapper 206 may store the state information of the second agent and/or may terminate the process corresponding to the second agent based on the command.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving a request to initiate a workflow process;
determining one or more agents for implementing the workflow process based on a manifest that describes the functionality of the workflow process;
determining that a first agent of the determined one or more agents is uninitiated;
generating first code that performs a first portion of the functionality corresponding to the first agent in response to determining that the first agent of the determined one or more agents is uninitiated; and
executing the workflow process based on at least the first code generated for the first agent.

2. The computer-implemented method of claim 1, further comprising:
detecting an event for initiating a second agent of the one or more agents;
in response to detecting the event, determining that the second agent is already initiated and in an idle state; and
causing the second agent to transition to an active state,
wherein the executing the workflow process comprises executing the workflow process based on at least the first code generated for the first agent and second code generated for the second agent.

3. The computer-implemented method of claim 1, wherein determining the one or more agents for implementing the workflow process based on the manifest comprises:
determining the workflow process from a plurality of workflow processes based on the request;
reading the manifest, from a plurality of manifests, based on the determined workflow process; and
determining the one or more agents based on reading the manifest.

4. The computer-implemented method of claim 1, wherein the manifest comprises a natural language-based description that describes the functionality of the workflow process and at least one of access privileges or access restrictions of the workflow process.

5. The computer-implemented method of claim 4, wherein generating the first code comprises:
generating the first code based on a large language model that analyzes the natural language-based description of the manifest.

6. The computer-implemented method of claim 1, further comprising:
determining that a second agent of the one or more agents has been in an idle state for a predetermined time period;
terminating execution of the second agent based on determining that the second agent has been in the idle state for the predetermined time period.

7. The computer-implemented method of claim 1, further comprising:
determining that a second agent of the one or more agents is in an active state and has not received a request to perform an operation for a predetermined time period; and
causing the second agent to transition to an idle state based on determining that the second agent is in the active state and has not received the request to perform the operation for the predetermined time period.

8. A system, comprising:
a memory; and
at least one processor coupled to the memory and configured to:
receive a request to initiate a workflow process;
determine one or more agents for implementing the workflow process based on a manifest that describes the functionality of the workflow process;
determine that a first agent of the determined one or more agents is uninitiated;
generate first code that performs a first portion of the functionality corresponding to the first agent in response to determining that the first agent of the determined one or more agents is uninitiated; and
execute the workflow process based on at least the first code generated for the first agent.

9. The system of claim 8, wherein the at least one processor is further configured to:
detect an event for initiating a second agent of the one or more agents;
in response to detecting the event, determine that the second agent is already initiated and in an idle state; and
cause the second agent to transition to an active state,
wherein, to execute the workflow process, the at least one processor is configured to execute the workflow process based on at least the first code generated for the first agent and second code generated for the second agent.

10. The system of claim 8, wherein, to determine the one or more agents for implementing the workflow process based on the manifest, the at least one processor is configured to:
determine the workflow process from a plurality of workflow processes based on the request;
read the manifest, from a plurality of manifests, based on the determined workflow process; and
determine the one or more agents based on reading the manifest.

11. The system of claim 8, wherein the manifest comprises a natural language-based description that describes the functionality of the workflow process and at least one of access privileges or access restrictions of the workflow process.

12. The system of claim 11, wherein, to generate the first code, the at least one processor is configured to:
generate the first code based on a large language model that analyzes the natural language-based description of the manifest.

13. The system of claim 8, wherein the at least one processor is further configured to:
determine that a second agent of the one or more agents has been in an idle state for a predetermined time period;
terminate execution of the second agent based on determining that the second agent has been in the idle state for the predetermined time period.

14. The system of claim 8, wherein the at least one processor is further configured to:
determine that a second agent of the one or more agents is in an active state and has not received a request to perform an operation for a predetermined time period; and
cause the second agent to transition to an idle state based on determining that the second agent is in the active state and has not received the request to perform the operation for the predetermined time period.

15. A non-transitory computer-readable medium having instructions stored thereon that, when executed by at least one computing device, causes the at least one computing device to perform operations, the operations comprising:
receiving a request to initiate a workflow process;
determining one or more agents for implementing the workflow process based on a manifest that describes the functionality of the workflow process;
determining that a first agent of the determined one or more agents is uninitiated;
generating first code that performs a first portion of the functionality corresponding to the first agent in response to determining that the first agent of the determined one or more agents is uninitiated; and
executing the workflow process based on at least the first code generated for the first agent.

16. The non-transitory computer-readable medium of claim 15, the operations further comprising:
detecting an event for initiating a second agent of the one or more agents;
in response to detecting the event, determining that the second agent is already initiated and in an idle state; and
causing the second agent to transition to an active state,
wherein the executing the workflow process comprises executing the workflow process based on at least the first code generated for the first agent and second code generated for the second agent.

17. The non-transitory computer-readable medium of claim 15, wherein determining the one or more agents for implementing the workflow process based on the manifest comprises:
determining the workflow process from a plurality of workflow processes based on the request;
reading the manifest, from a plurality of manifests, based on the determined workflow process; and
determining the one or more agents based on reading the manifest.

18. The non-transitory computer-readable medium of claim 15, wherein the manifest comprises a natural language-based description that describes the functionality of the workflow process and at least one of access privileges or access restrictions of the workflow process.

19. The non-transitory computer-readable medium of claim 18, wherein generating the first code comprises:
generating the first code based on a large language model that analyzes the natural language-based description of the manifest.

20. The non-transitory computer-readable medium of claim 15, the operations further comprising:
determining that a second agent of the one or more agents has been in an idle state for a predetermined time period;
terminating execution of the second agent based on determining that the second agent has been in the idle state for the predetermined time period.
